(19) United States
(12) Patent Application Publication
(10) Pub. No.: US 2025/0250043 A1
(43) Pub. Date: Aug. 7, 2025

(54) VACUUM SEALING MACHINE CAPABLE OF WORKING CONTINUOUSLY

(71) Applicant: Bonsen Electronics Limited, Dongguan City (CN)

(72) Inventors: Xinfu Qin, Dongguan City (CN); Songde Ye, Dongguan City (CN)

(21) Appl. No.: 18/907,518

(22) Filed: Oct. 5, 2024

(30) Foreign Application Priority Data
Feb. 4, 2024 (CN) 202410158718.7

(51) Int. Cl. B65B 31/02; B29C 65/00

(52) U.S. Cl. CPC B65B 31/02; B29C 66/81455

(57) ABSTRACT

A vacuum sealing machine capable of working continuously contains: a body, a sealing element, a covering mechanism y, a control circuit, an air drawing pump, an air feeding pump, and an exhaust tank. The sealing element and the covering mechanism moveably contact with each other to close the exhaust tank before vacuuming. In a heat sealing process, a mouth of the vacuum packaging bag is pressed by the sealing element. The body includes the inflatable press strap in which an inflatable cavity is defined, and the air feeding pump is communicated with the inflatable press strap. After the sealing element contacts with the covering mechanism, the inflatable press strap is not inflated and maintains a predetermined distance apart from the sealing element. In the heat sealing process, the inflatable press strap is inflated to expand the inflatable press strap and to movably abut against the sealing element.

### TECHNICAL FIELD

The present invention relates to a vacuum sealing machine, and more particularly to the vacuum sealing machine which is capable of working continuously.

### BACKGROUND

A conventional vacuum sealer is a small household kitchen appliance that evacuates the air from the vacuum packaging bag through a built-in small vacuum pump and an air extraction tank. After the vacuum is completed, the bag mouth of the packaging bag is hot-melted and solidified to form a sealing strip that seals the bag mouth. The sealing element includes a mounting base disposed on the main body, a horizontally arranged heating wire fixed on the upper part of the mounting base, and a heating wire covering the upper part of the bag. During the entire process of vacuuming and heat sealing, the sealing strip installed on the upper cover always presses against the insulation layer of the sealing element and maintains pressure, which makes it extremely difficult to dissipate heat from the heating wire.

The vacuum sealing machine does not have a heat dissipation device and does not have enough space to fix a heat dissipation device for the sealing element. The sealing element cools down extremely slowly, so the temperature of the heating wire will gradually increase during continuous operation. Thus, disadvantages occur as follows:

First, the temperature of the heating wire of the vacuum sealing machine is too high due to poor heat dissipation, which makes the vacuum sealing machine unable to work continuously for a long time.

Second, if the temperature of the heating wire is too high, it may accidentally burn the user.

Third, if the temperature of the heating wire is too high, it will burn or burn through the vacuum packaging bag, thus making it impossible to vacuum.

Fourth, the hot-melt sealing strip formed during the heat sealing stage will also cause deformation of the bag mouth due to excessive heating time. The hot-melt sealing strip formed will also become thinner and deformed, thus making it very easy to leak airs, and the sealing effect will be greatly reduced.

The present invention has arisen to mitigate and/or obviate the afore-described disadvantages.

### SUMMARY

The primary aspect of the present invention is to provide a vacuum sealing machine which is capable of working continuously, simplified, and enhancing heat dissipation.

To obtain above-mentioned aspect, a vacuum sealing machine capable of working continuously contains: a body, a sealing element and a covering mechanism which are connected on the body, a control circuit received in the body, an air drawing pump, an air feeding pump, and an exhaust tank defined in the body, located beside the sealing element and configured to draw airs from a vacuum packaging bag. An exhaust interface of the air drawing pump is in communication with the exhaust tank via a first air pipe, the control circuit is electrically connected with the air drawing pump, the air feeding pump and the sealing element. The sealing element and the covering mechanism moveably contact with each other to close the exhaust tank before vacuuming. In a heat sealing process, a mouth of the vacuum packaging bag is pressed by the sealing element. The body includes the inflatable press strap in which an inflatable cavity is defined, and an exhaust interface of the air feeding pump is in communication with the inflatable press strap via a second air pipe. After the sealing element contacts with the covering mechanism, the inflatable press strap is not inflated and maintains a predetermined distance apart from the sealing element. In the heat sealing process, the inflatable press strap is inflated to expand the flexible wall of the inflatable press strap and to movably abut against the sealing element.

Preferably, in the heat sealing process, the inflatable press strap is inflated to expand and to movably abut against the sealing element. In any working process other than the heat sealing process, the inflatable press strap is not inflated to retract, and a set distance between a bottom of the inflatable press strap and a top of the heating element is produced.

Thereby, the inflatable press strap of the present invention is configured to replace the conventional sealing strip.

In the set working mode or in the non-heat sealing working mode, the inflatable press strap and the sealing element are relatively separated to avoid a slow speed of reducing the temperature of the sealing element, and the vacuum sealing machine is capable of working continuously.

### BRIEF DESCRIPTION OF THE DRAWINGS

FIG. 1 is a perspective view showing the assembly of a vacuum sealing machine according to a preferred embodiment of the present invention.

FIG. 2 is another perspective view showing the assembly of the vacuum sealing machine according to the preferred embodiment of the present invention.

FIG. 3 is a perspective view showing the assembly of a part of the vacuum sealing machine according to the preferred embodiment of the present invention.

FIG. 4 is another perspective view showing the assembly of a part of the vacuum sealing machine according to the preferred embodiment of the present invention.

FIG. 5 is also another perspective view showing the assembly of a part of the vacuum sealing machine according to the preferred embodiment of the present invention.

FIG. 6 is still another perspective view showing the assembly of a part of the vacuum sealing machine according to the preferred embodiment of the present invention.

### DETAILED DESCRIPTION

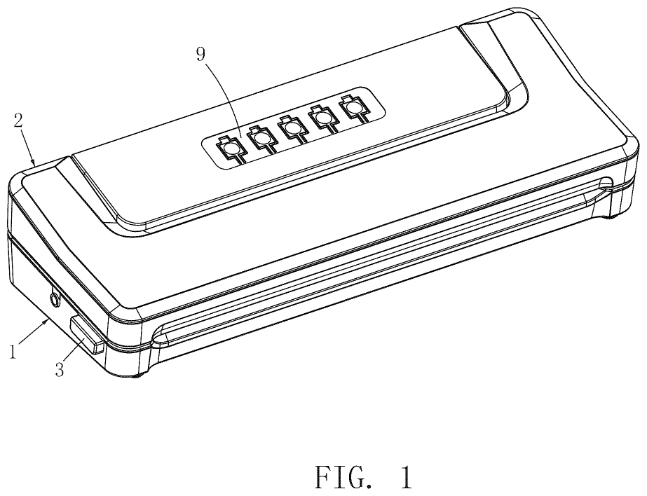

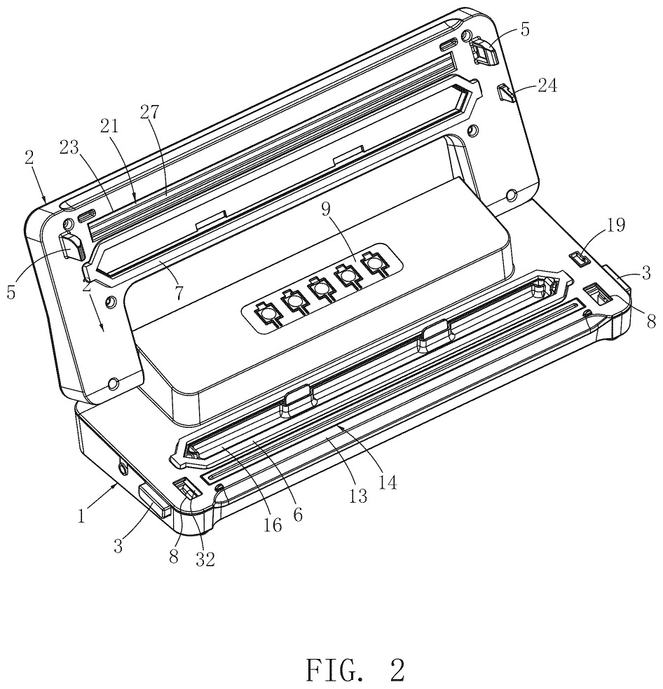

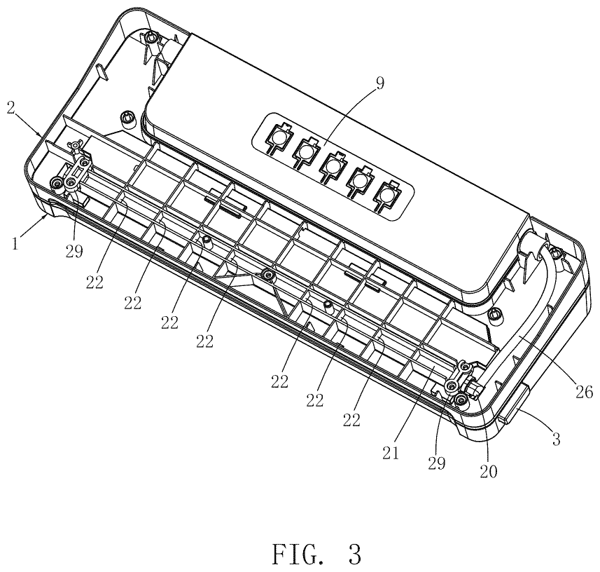

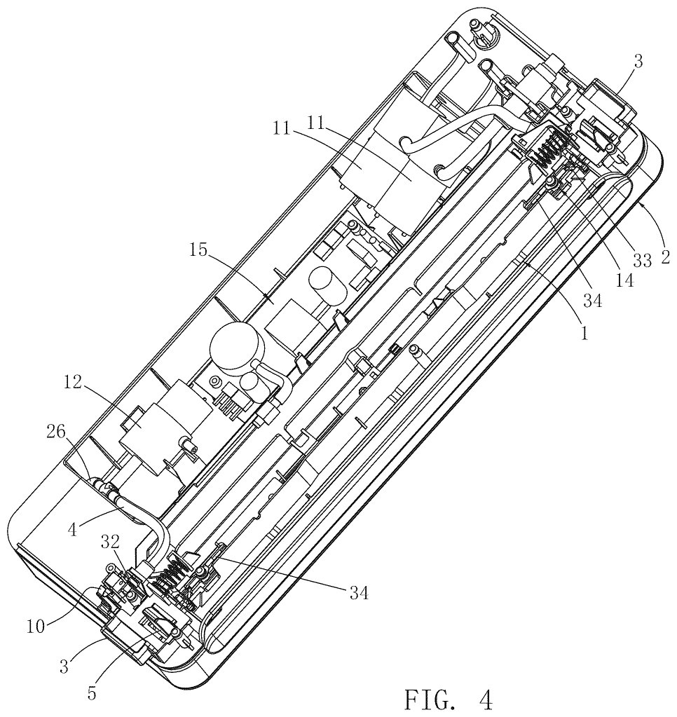

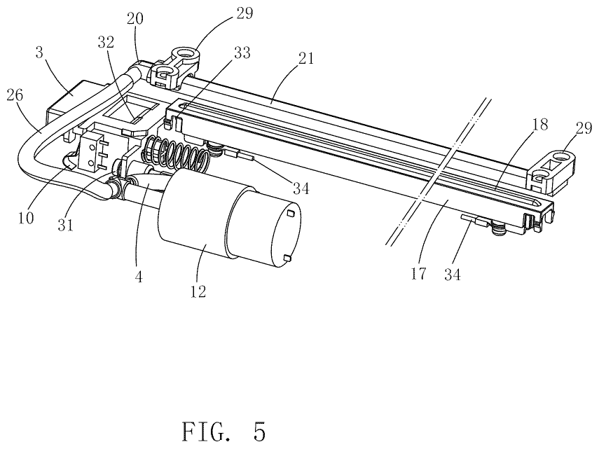

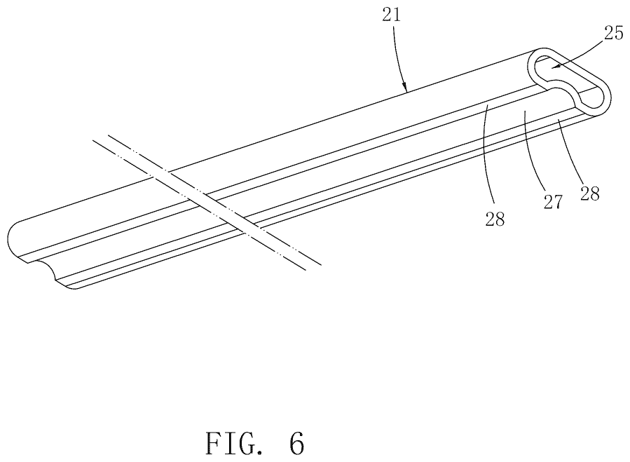

With reference to FIGS. 1-6, a vacuum sealing machine capable of working continuously according to a preferred embodiment of the present invention comprises: a body 1, a sealing element 14 and a covering mechanism which are connected on the body 1, a control circuit 15 received in the body 1, an air drawing pump 11, an air feeding pump 12, and an exhaust tank 16 defined in the body 1, located beside the sealing element 14 and configured to draw airs from a vacuum packaging bag, wherein an exhaust interface of the air drawing pump 11 is in communication with the exhaust tank 16 via a first air pipe, the control circuit 15 is electrically connected with the air drawing pump 11, the air feeding pump 12 and the sealing element 14, wherein the sealing element 14 and the covering mechanism moveably contact with each other to close the exhaust tank 16 before vacuuming, In a heat sealing process, a mouth of the vacuum packaging bag is pressed by the sealing element, wherein the covering mechanism includes a cap 2, a rear end of the cap 2 is rotatably connected on a rear end of a top of the body 1, the body 1 further includes a sealing work zone 13 formed on a front end of the top thereof and configured to accommodate the sealing element 14, and two sides of the sealing element 14 respectively extend to two sides of the sealing work zone 13. The cap 2 includes an inflatable press strap 21 disposed on a front end of a bottom thereof.

The sealing element 14 includes an insulation seat 17, a heating element 33, and at least one insulating layer 18, wherein the heating element 33 extends from a top of the insulation seat 17, and at least one insulating layer 18 is covered on the heating element 33. The heating element 33 respectively includes a heat wire extending from a top of the sealing element 14, a bottom of the inflatable press strap 21 is a flexible wall made of flexible silicone. When the inflatable press strap 21 abuts against the sealing element 14, the flexible wall of the inflatable press strap 21 is stopped to deformably contact with the top of sealing element and to cover the heat wire of the at least one insulating layer 33, thus enhancing a heat sealing effect and reducing a heat loss and a sealing time.

In the heat sealing process, the inflatable press strap 21 contacts with and covers the heating element 33, wherein in any working process other than the heat sealing process, a set distance between the bottom of the flexible wall of the inflatable press strap 21 and the top of the heating element 33 is within 0.2 cm to 1 cm. Preferably, the set distance is 0.3 cm to 0.5 cm. In any working process other than the heat sealing process, the inflatable press strap 21 does not contact with the sealing element 14 and the heating element 33.

The body 1 includes the inflatable press strap 21 in which an inflatable cavity 25 is defined, an exhaust interface of the air feeding pump 12 is in communication with the inflatable press strap 21 via a second air pipe 26, wherein the second air pipe 26 extends into the cap 2 from the body 1 via a coupling orifice of a rotary shaft of the body 1. After the sealing element 14 contacts with the covering mechanism, the inflatable press strap 21 is not inflated and maintains a predetermined distance apart from the sealing element 14. In the heat sealing process, the inflatable press strap 21 is inflated to expand the flexible wall of the inflatable press strap 21 and to movably abut against the sealing element 14, hence the bottom of the inflatable press strap 21 contacts with the top of the sealing element 14 matingly. In any working process other than the heat sealing process, the inflatable press strap 21 is not inflated to retract back to an accommodation room, hence the set distance between the bottom of the inflatable press strap 21 and the top of the heating element 33 is produced.

Preferably, the inflatable press strap 21 is inflated and deflated within 1 second, when the inflatable press strap 21 is deflated, the inflatable press strap 21 retracts back to the accommodation room quickly to produce a negative pressure above the heat wire of the heating element 33, thus increasing a temperature and a pressure of the heat wire. Thereafter, airs around the heat wire is pushed upward to reduce the temperature of the sealing element 14 quickly.

The inflatable press strap 21 has a receiving groove 27 defined on a central portion of a bottom thereof and configured to accommodate the heating element 33 which is covered by the at least one insulating layer 18, wherein the receiving groove 27 extends along a length of the inflatable press strap 21, two abutting portions 28 respectively formed beside two sides of the receiving groove 27 and configured to contact with the insulation seat 17. When the inflatable press strap 21 abuts against the sealing element 14, a pressure between the inflatable press strap 21 and the heating element 33 is equal to a pressure between the heating element 33 and the insulation seat 17, a height of the receiving groove 27 does not align with a height of the mouth of the vacuum packaging bag so as to maintain a fixed pressure of multiple pressed positions of the vacuum packaging bag, when the vacuum packaging bag is heat sealed. A pressure and a heated temperature of a heat sealing zone of the mouth of the vacuum packaging bag are balanced stably. Preferably, the heat sealing effect and the heated temperature of the heat sealing zone of the mouth of the vacuum packaging bag are even, thus enhancing a heat sealing quality.

Alternatively, the heat wire of the heating element 33 is a laminated film, two sides of the heating element 33 respectively extend to two sides of a bottom of the insulation seat 17 and are electrically connected with two electrode connections 34 and the control circuit 15, thus supplying a power to the heating element 33.

The cap 2 includes the accommodation room defined therein, multiple spaced partition sheets 22 one-piece extending from a length of the inflatable press strap 21 and located above the accommodation room, and a defining trench 23 located below the accommodation room and passing through the bottom of the cap 2. The inflatable press strap 21 is flat and is received in the accommodation room of the cap 2, wherein the multiple spaced partition sheets 22 abut against a top of the inflatable press strap 21, when the inflatable press strap 21 is deflated, the bottom of the inflatable press strap 21 retracts into or above the defining trench 23 so as to maintain the predetermined distance of the inflatable press strap 21 apart from the sealing element 14. When the inflatable press strap 21 is inflated to expand below the bottom of the cap 2 so as to abut against the sealing element 14. Thereby, the inflatable press strap 21 is inflated by the air feeding pump 12 to expand and abut against the sealing element 14. The inflatable press strap 21 is communicated with an external environment via two pressure discharge tubes 4 so as to be deflated to retract back into the defining trench 23.

Accordingly, the inflatable press strap 21 is expandable and retractable quickly and stably by using the air feeding pump 12 and the air drawing pump 11 with a less power, thus reducing power consumption. Preferably, a shape of the inflatable press strap 21 is limited in a predetermined shape by the defining trench 23. After deflating the inflatable press strap 21, the inflatable press strap 21 retracts back into the defining trench 23 quickly to accelerate a flow speed of the airs around the sealing element 14, thus decreasing the temperature quickly.

The cap 2 further includes a contact foot 24 extending from the bottom thereof and received in a through orifice 19 of the top of the body 1. The body 1 further includes a control switch 10 accommodated therein and mating with the contact foot 24 in a contacting manner or a sensing manner, wherein the control circuit 15 is electrically contact with the control switch 10 to turn on the air feeding pump 12 to inflate after the control switch 10 is conducted and the control circuit 15 turns on the sealing element 14. The inflatable press strap 21 is not overly inflated to expand and remove from the defining trench 23 in a program controlling manner or by using the control switch 10.

The cap 2 further includes two retainers 29 extending thereon, the inflatable press strap 21 includes a seal segment formed on a first end thereof, a rotation interface 20 formed on a second end of the inflatable press strap 21 and having an air passageway, wherein the rotation interface 20 is in an L shape and includes a first end inserted into the first end of the inflatable press strap 21, and a second end inserted into the second air pipe 26, wherein the two retainers 29 are respectively locked on the cap 2 by using two screws, wherein a first retainer 29 is locked on the first end of the inflatable press strap 21, and a second retainer 29 is locked on the second end of the inflatable press strap 21. The body 1 further includes two release buttons 3 respectively formed on two sides thereof, wherein the first air pipe and the second air pipe 26 are respectively communicated with the two pressure discharge tubes 4, and the two release buttons 3 respectively include two discharge portions 31 moving therewith and abutting against the two pressure discharge tubes 4.

The exhaust tank 16 is defined on a rear end of the sealing work zone 13, the exhaust tank 16 has a first seal washer 6 surrounding therearound, and the cap 2 includes a second seal washer 7 mounted on the bottom thereof, such that the exhaust tank 16 is closed by the first seal washer 6 and the second seal washer 7. The cap 2 further includes two locking posts 5 extending from the bottom thereof and accommodated in two connection orifices 8 of the top of the body 1, wherein two ends of the sealing work zone 13 correspond to the two connection orifices 8, and the two release buttons 3 includes two locating portions 32 configured to correspond to the two locking posts 5. The two locating portions 32 and the two discharge portions 31 are located in the body 1, the locating portions 32 are located below the two connection orifices 8, and the locking posts 5 are located on two sides of the bottom of the cap 2, such that the two locking posts 5 are locked with the locating portions 32 via the two connection orifices 8.

The body 1 further includes a control platform 9 or a touch screen disposed on the top thereof, electrically connected with the control circuit 15, and configured to control the vacuum sealing machine and display a working state of the vacuum sealing machine.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. A vacuum sealing machine capable of working continuously comprising: a body, a sealing element and a covering mechanism which are connected on the body, a control circuit received in the body, an air drawing pump, an air feeding pump, and an exhaust tank defined in the body, located beside the sealing element and configured to draw airs from a vacuum packaging bag, wherein an exhaust interface of the air drawing pump is in communication with the exhaust tank via a first air pipe, the control circuit is electrically connected with the air drawing pump, the air feeding pump and the sealing element, wherein the sealing element and the covering mechanism moveably contact with each other to close the exhaust tank before vacuuming; in a heat sealing process, a mouth of the vacuum packaging bag is pressed by the sealing element;
wherein the body includes the inflatable press strap in which an inflatable cavity is defined, an exhaust interface of the air feeding pump is in communication with the inflatable press strap via a second air pipe;
wherein after the sealing element contacts with the covering mechanism, the inflatable press strap is not inflated and maintains a predetermined distance apart from the sealing element; and in the heat sealing process, the inflatable press strap is inflated to expand the flexible wall of the inflatable press strap and to movably abut against the sealing element.

2. The vacuum sealing machine as claimed in claim 1, wherein the covering mechanism includes a cap, a rear end of the cap is rotatably connected on a rear end of a top of the body, the body further includes a sealing work zone formed on a front end of the top thereof and configured to accommodate the sealing element, and two sides of the sealing element respectively extend to two sides of the sealing work zone; the cap includes an inflatable press strap disposed on a front end of a bottom thereof, and an exhaust tank is defined behind the sealing work zone.

3. The vacuum sealing machine as claimed in claim 2, wherein in the heat sealing process, the inflatable press strap is inflated to expand and to movably abut against the sealing element; in any working process other than the heat sealing process, the inflatable press strap is not inflated to retract, and a set distance between a bottom of the inflatable press strap and a top of the heating element is produced.

4. The vacuum sealing machine as claimed in claim 3, wherein the sealing element includes an insulation seat, a heating element, and at least one insulating layer, wherein the heating element extends from a top of the insulation seat, and at least one insulating layer is covered on the heating element; a bottom of the inflatable press strap is a flexible wall made of flexible silicone, when the inflatable press strap abuts against the sealing element, the flexible wall of the inflatable press strap is stopped to deformably contact with the top of sealing element and to cover the heat wire of the at least one insulating layer; wherein in any working process other than the heat sealing process, a set distance between the bottom of the flexible wall of the inflatable press strap and the top of the heating element is produced.

5. The vacuum sealing machine as claimed in claim 4, wherein the inflatable press strap has a receiving groove defined on a central portion of a bottom thereof and configured to accommodate the heating element which is covered by the at least one insulating layer, wherein the receiving groove extends along a length of the inflatable press strap, two abutting portions respectively formed beside two sides of the receiving groove and configured to contact with the insulation seat.

6. The vacuum sealing machine as claimed in claim 5, wherein the cap includes the accommodation room defined therein, multiple spaced partition sheets one-piece extending from a length of the inflatable press strap and located above the accommodation room, and a defining trench located below the accommodation room and passing through the bottom of the cap; the inflatable press strap is flat and is received in the accommodation room of the cap, wherein the multiple spaced partition sheets abut against a top of the inflatable press strap, when the inflatable press strap is deflated, the bottom of the inflatable press strap retracts into or above the defining trench so as to maintain the predetermined distance of the inflatable press strap apart from the sealing element; when the inflatable press strap is inflated to expand below the bottom of the cap so as to abut against the sealing element.

7. The vacuum sealing machine as claimed in claim 5, wherein the cap further includes a contact foot extending from the bottom thereof and received in a through orifice of the top of the body, the body further includes a control switch accommodated therein and mating with the contact foot in a contacting manner or a sensing manner, wherein the control circuit is electrically contact with the control switch to turn on the air feeding pump to inflate after the control switch is conducted and the control circuit turns on the sealing element, wherein the set distance between the bottom of the flexible wall of the inflatable press strap and the top of the heating element is within 0.2 cm to 1 cm.

8. The vacuum sealing machine as claimed in claim 5, wherein the cap further includes two retainers extending thereon, the inflatable press strap includes a seal segment formed on a first end thereof, a rotation interface formed on a second end of the inflatable press strap and having an air passageway, wherein the rotation interface includes a first end inserted into the first end of the inflatable press strap, and a second end inserted into the second air pipe, wherein the two retainers are respectively locked on the cap, a first retainer is locked on the first end of the inflatable press strap, and a second retainer is locked on the second end of the inflatable press strap.
